(19) United States
(12) Patent Application Publication
(10) Pub. No.: US 2010/0088855 A1
(43) Pub. Date: Apr. 15, 2010

(54) VEHICLE DOOR HANDLE ASSEMBLY

(75) Inventors: James A. Ruse, Allegan, MI (US); Brett A. Gorby, Grand Rapids, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: MAGNA MIRRORS OF AMERICA, INC., Holland, MI (US)

(21) Appl. No.: 12/577,272

(22) Filed: Oct. 12, 2009

Related U.S. Application Data
(60) Provisional application No. 61/161,792, filed on Mar. 20, 2009.
(60) Provisional application No. 61/105,108, filed on Oct. 14, 2008.

(51) Int. Cl. B25G 3/00; E05B 1/00; B25G 1/00

(52) U.S. Cl. 16/412

(57) ABSTRACT

A door handle assembly for a vehicle includes a bracket mountable to the vehicle door, a handle portion configured to pivotally attach to the bracket and an actuating element pivotally mounted to the bracket. The actuating element connects to a release mechanism of the vehicle door so as to actuate the release mechanism when the actuating element is pivoted relative to the bracket. The door handle assembly may include a counterweight pivotally mounted to the bracket, with the counterweight extending along the bracket, such that the counterweight and the bracket comprise a low profile assembly. The door handle assembly may include an inertial catch pivotally mounted to the bracket, wherein pivotal movement of the handle portion imparts a pivotal movement of the inertial catch during normal operation of the door handle assembly to open the vehicle door.

### CROSS REFERENCE TO RELATED APPLICATIONS

The present application claims benefit of U.S. provisional applications, Ser. No. 61/161,792, filed Mar. 20, 2009; and Ser. No. 61/105,108, filed Oct. 14, 2008, which are hereby incorporated herein by reference in their entireties.

### FIELD OF THE INVENTION

The present invention relates to door handles for vehicles and, more particularly, to an exterior door handle for opening a side door of a vehicle.

### BACKGROUND OF THE INVENTION

Typically, a door handle for a vehicle may include, a handle portion that is pivotable relative to a base portion, whereby pivotal movement of the handle portion pulls at a cable to move a latch mechanism to release the latch and open the door. Due to the weight or mass of the pivotable handle portion, the handle portion tends to swing or pivot outward during a vehicle collision and may open the door of the vehicle during the collision. The door handle thus often includes a counterweight and lever mechanism that extends substantially into the door cavity (behind the exterior panel of the door), in order to counter the weight and inertia of the pivotable handle portion to retain the door handle in its non-opening position during a vehicle collision. The counterweight, along with the other door handle components, often requires the door to have a greater width (or greater distance between the exterior door panel and the window, which may be lowered or rolled down to be within the door cavity) that is sufficient to receive the counterweight and door handle components when the door handle is mounted to the door.

### SUMMARY OF THE INVENTION

The present invention provides a door handle assembly that includes a counterweight and lever mechanism at the base of the door handle assembly, such that the components do not extend substantially into the door cavity.

According to an aspect of the present invention, a door handle assembly for a door of a vehicle includes a bracket or base portion mountable to the vehicle door, and a handle portion and an actuating element movably mounted to the base portion. The actuating element is connected to a latch mechanism of the door and moves in response to movement of the handle portion to release the latch mechanism to open the door of the vehicle. The handle assembly includes a counterweight, which comprises a low profile counterweight that is movably disposed at the bracket with a pivot joint and a weight disposed forward of the actuating element when the door handle assembly is normally mounted at a vehicle door.

The vehicle door may provide an outer door sheet metal component that is configured with an indentation for hand clearance at the door handle assembly. The counterweight may be pivotally mounted to the bracket and may extend along the bracket above and below the hand clearance.

The low profile characteristic of the bracket and counterweight allows the door handle assembly to be implemented in narrower or reduced profile doors, where the bracket and counterweight may be disposed in a narrow space between the outer door panel and the movable glass window of the door assembly when the glass window is at least partially lowered into the door cavity. For example, the bracket and counterweight may have a profile or lateral dimension (when mounted to a vehicle door) that is about one and three quarters of an inch or less, depending on the particular application of the door handle assembly and vehicle door.

Optionally, the door handle assembly of the present invention may utilize a bell crank that can be staged for easy of product assembly into a vehicle. The staged bell crank and bracket may cooperate to allow for loading of the handle portion or strap handle without interference, and may allow for unstaging of the bell crank (to move the bell crank to its operational position) via pulling at the handle portion or strap handle after assembly of the door handle at the vehicle door.

The counterweight is interconnected with the handle portion such that pivotal movement of the handle portion to open the vehicle door imparts a pivotal movement of the counterweight. Thus, the counterweight is pivoted or cycled each time the door is opened via pivotal movement of the handle portion. Such cycling limits or substantially precludes any accumulation of dirt, dust or other contaminants at the counterweight that may restrict pivotal movement of the counterweight during a sudden stop or collision of the vehicle.

According to another aspect of the present invention, a vehicle door handle assembly for a door of a vehicle includes a bracket mountable to the vehicle door, a handle portion, an actuating element and a counterweight or inertia element or inertial catch. The handle portion is configured to pivotally attach to the bracket and is pivotable between an initial position, where the handle portion is positioned generally along the vehicle door, and an actuating position, where the handle portion is pivoted away from the vehicle door. Pivotal movement of the handle portion actuates a release mechanism of the vehicle door to open the vehicle door. The inertial catch is pivotally mounted to the bracket, wherein pivotal movement of the handle portion imparts a pivotal movement of the inertial catch during normal operation of the door handle assembly to open the vehicle door.

The handle portion may be pivotable about a generally horizontal pivot axis or a generally vertical pivot axis when the door handle assembly is normally mounted at a door of a vehicle. The door handle assembly may include an actuating element that is pivotable with the handle portion (and may be unitarily formed with the handle portion so as to be part of the handle portion) and that is connected to the release mechanism of the vehicle door so as to actuate the release element when the actuating element is pivoted relative to the bracket. Optionally, the handle portion or actuating element may include a guide pin extending therefrom, and the guide pin may engage a guide channel of the inertial catch, and wherein pivotal movement of the handle portion imparts movement of the guide pin which moves along the guide channel to impart pivotal movement of the inertial catch.

Therefore, the present invention provides a door handle assembly that extends a reduced amount into the vehicle door, such that the vehicle door may have a reduced thickness and the handle assembly may be mounted at or adjacent to or outward from a movable window track of the vehicle door and the bracket or base portion may fit within the space between the outer panel of the door and the glass window of the door when the window is in its lowered position. The door handle assembly thus packages a large counter balance or counterweight into a small area, allowing for a thinner door structure design while allowing for a larger or heavier door handle. This is accomplished by mounting the counter balance or weight forward of the door handle pocket. Mounting the weights or slugs of the counterweight on each side of the backing bracket allows for a tighter or lower profile package within the vehicle door. The counterweight may be designed so that the pivot points require limited pivotal range of travel of the counter balance, and limiting the travel to be about the thickness of the bracket. The counterweight or inertial catch may be pivoted or cycled during each cycling or actuation of the door handle portion to open the door of the vehicle.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a door handle assembly in accordance with the present invention;

FIG. 2A is an upper plan view of the door handle assembly, with the door handle assembly removed from the vehicle door, and shown with the handle portion in its home or closed position;

FIG. 2B is a side elevation of the door handle assembly of FIG. 2A, as viewed from inside the vehicle door;

FIG. 2C is an end elevation of the door handle assembly of FIG. 2A;

FIG. 3A is a plan view of the door handle assembly, with the door handle assembly removed from the vehicle door, and shown with the handle portion in its opened or pulled out position;

FIG. 3B is a side elevation of the door handle assembly of FIG. 3A, as viewed from inside the vehicle door;

FIG. 3C is an end elevation of the door handle assembly of FIG. 3A;

FIG. 4 is a perspective view of the bracket and counterweight assembly of the door handle assembly of the present invention;

FIG. 5A is an upper plan view of the bracket and counterweight assembly of FIG. 4;

FIG. 5B is a side elevation of the bracket and counterweight assembly of FIG. 4;

FIG. 5C is a lower plan view of the bracket and counterweight assembly of FIG. 4;

FIG. 5D is an end elevation of the bracket and counterweight assembly of FIG. 4;

FIG. 6 is a perspective view of the bracket of the door handle assembly of the present invention;

FIG. 7A is an upper plan view of the bracket of FIG. 6;

FIG. 7B is a side elevation of the bracket of FIG. 6;

FIG. 7C is a lower plan view of the bracket of FIG. 6;

FIG. 7D is an end elevation of the bracket of FIG. 6;

FIG. 8 is a perspective view of the counterweight of the door handle assembly of the present invention;

FIGS. 9A-C are elevations of the counterweight of FIG. 8;

FIG. 10A is a perspective view of the actuating element of the door handle assembly of the present invention;

FIGS. 10B-D are elevations of the actuating element of FIG. 10A;

FIG. 11 is a perspective view of the door handle assembly, shown in its staged position;

FIG. 12A is a plan view of the door handle assembly of FIG. 11;

FIG. 12B is a side elevation of the door handle assembly of FIG. 11, as viewed from inside the vehicle door;

FIG. 12C is an end elevation of the door handle assembly of FIG. 11;

FIG. 13A is an enlarged plan view of the actuating element of the door handle assembly of FIG. 12A;

FIG. 13B is an enlarged side elevation of the actuating element of the door handle assembly of FIG. 12B;

FIG. 13C is an enlarged end elevation of the actuating element of the door handle assembly of FIG. 12C;

FIG. 14 is a perspective view of the door handle assembly, shown in its tripped or unstaged position;

FIG. 15A is a plan view of the door handle assembly of FIG. 14;

FIG. 15B is a side elevation of the door handle assembly of FIG. 14;

FIG. 15C is an end elevation of the door handle assembly of FIG. 14;

FIG. 16A is an enlarged plan view of the actuating element of the door handle assembly of FIG. 15A;

FIG. 16B is an enlarged side elevation of the actuating element of the door handle assembly of FIG. 15B;

FIG. 16C is an enlarged end elevation of the actuating element of the door handle assembly of FIG. 15C;

FIG. 17 is a rear perspective view of another vehicle door handle assembly in accordance with the present invention;

FIG. 18 is a perspective view of an inertia element of the door handle assembly of FIG. 17;

FIG. 18A is a perspective view of a pin suitable for pivotally mounting the inertia element at the door handle assembly;

FIG. 18B is a perspective view of a pin suitable for mounting to and extending from an actuating arm of the door handle assembly;

FIG. 19 is another rear perspective view of the door handle assembly of FIG. 17, shown with the inertia element removed from the door handle assembly;

FIG. 20 is an enlarged perspective view of the door handle assembly of FIG. 17, shown with the handle being partially actuated and a guide pin of the actuating arm of the handle assembly initially engaging a guide slot or channel of the inertia element;

FIG. 21 is an enlarged perspective view similar to FIG. 20, showing the handle assembly with the handle being further actuated to move the pin along the channel of the inertia element to pivot the inertia element;

FIG. 22 is a perspective view of another vehicle door handle assembly in accordance with the present invention;

FIG. 23 is another perspective view of the vehicle door handle assembly of FIG. 22;

FIG. 24 is a rear perspective view of the vehicle door handle assembly of FIGS. 22 and 23, showing the door handle assembly from inside the door to which the door handle assembly is mounted;

FIG. 25 is another perspective view of the vehicle door handle assembly of FIGS. 22 and 23, showing the handle assembly when the strap handle is pulled outward to open the door of the vehicle; and

FIG. 26 is another perspective view of the vehicle door handle assembly of FIGS. 22 and 23, showing the inertial catch in an actuated orientation to limit or substantially preclude opening of the vehicle door.

### DESCRIPTION OF THE PREFERRED EMBODIMENTS

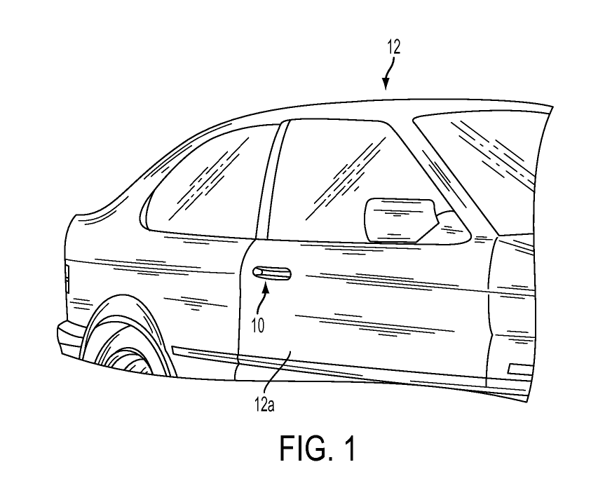

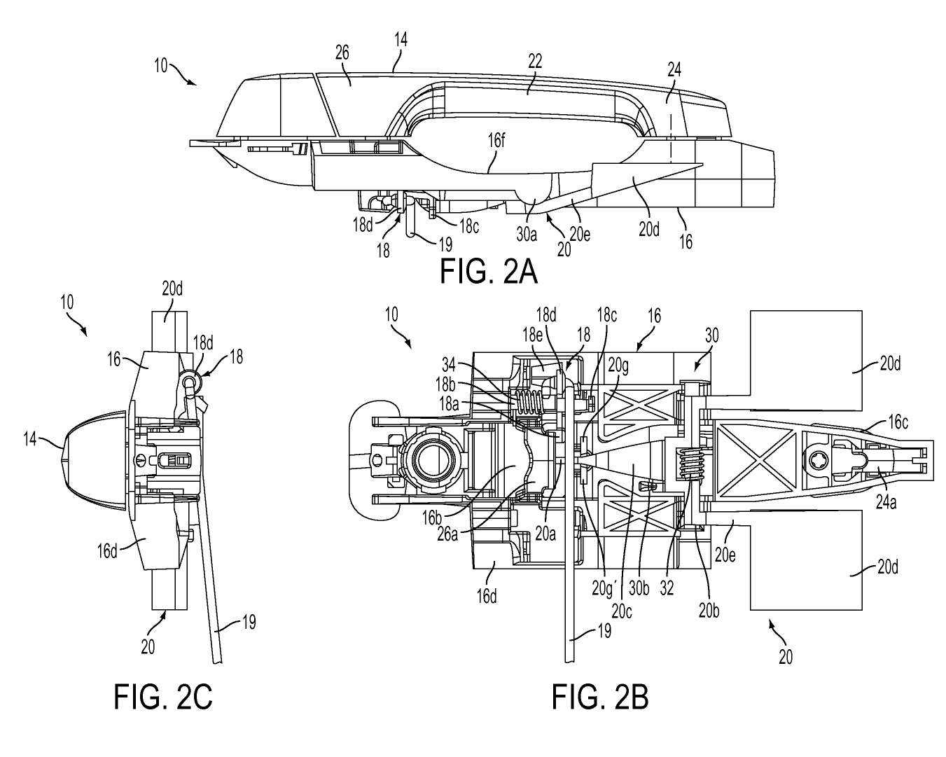

Referring now to the drawings and the illustrative embodiments depicted therein, a vehicle door handle assembly 10 is mountable to a door 12a of a vehicle 12 and operable to release a latch mechanism (not shown) of the door 12a to open the vehicle door (FIG. 1). Handle assembly 10 includes a handle portion 14 that is mountable to a base portion or bracket 16, which in turn is mounted to the vehicle door and within the vehicle door, an actuating lever or member or element or arm or bellcrank 18 pivotally mounted to bracket 16 and a counterweight or counterbalance 20 pivotally mounted to bracket 16 (FIGS. 2A-C and 3A-C). Actuating element 18 is connected to the door latch mechanism, such as via a cable or mechanical linkage or the like 19, such that pivotal movement by handle portion 14 imparts a pivotal movement of actuating element 18 to release the latch mechanism to open the vehicle door, as discussed below. Likewise, pivotal movement by handle portion 14 imparts a pivotal movement of counterweight 20, as also discussed below.

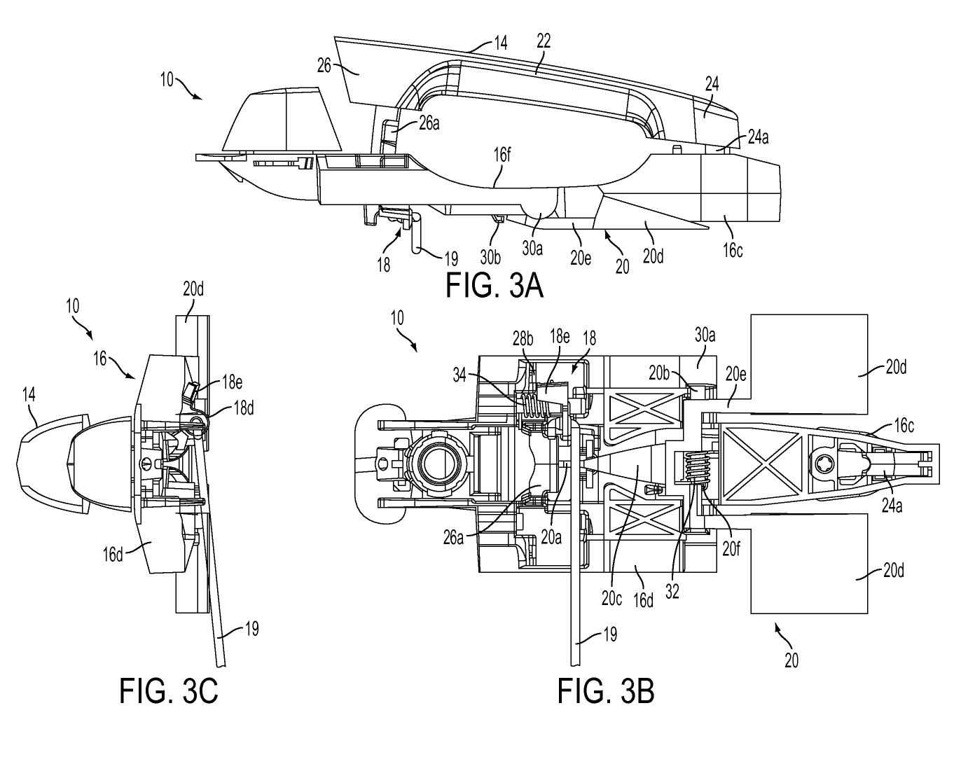

Handle portion 14 includes a grasping portion 22 and opposite end portions 24, 26, which mount the handle portion to the bracket 16 at the vehicle door. As best shown in FIGS. 2 and 3, front end portion 24 of handle portion 14 includes a mounting portion or element 24a that is pivotally received in or pivotally mounted to a front portion of bracket 16 so that the handle portion 14 is pivotable about a generally vertical pivot axis at the front end region of the handle portion when the handle assembly is mounted to a vehicle door. The rear end portion 26 of handle portion 14 includes a connecting portion or element 26a that is received through bracket 16 and connects to or engages a connecting element or arm 20a of counterweight 20 and a connecting element or arm 18a of actuating element 18, as discussed below. Thus, when grasping portion 22 is grasped and pulled outward from the vehicle door, the rear end portion 26 of handle portion 14 pulls outward (as shown in FIGS. 3A-C) at connecting arms or elements 18a and 20a of actuating element 18 and counterweight 20, respectively, to open the vehicle door, as also discussed below.

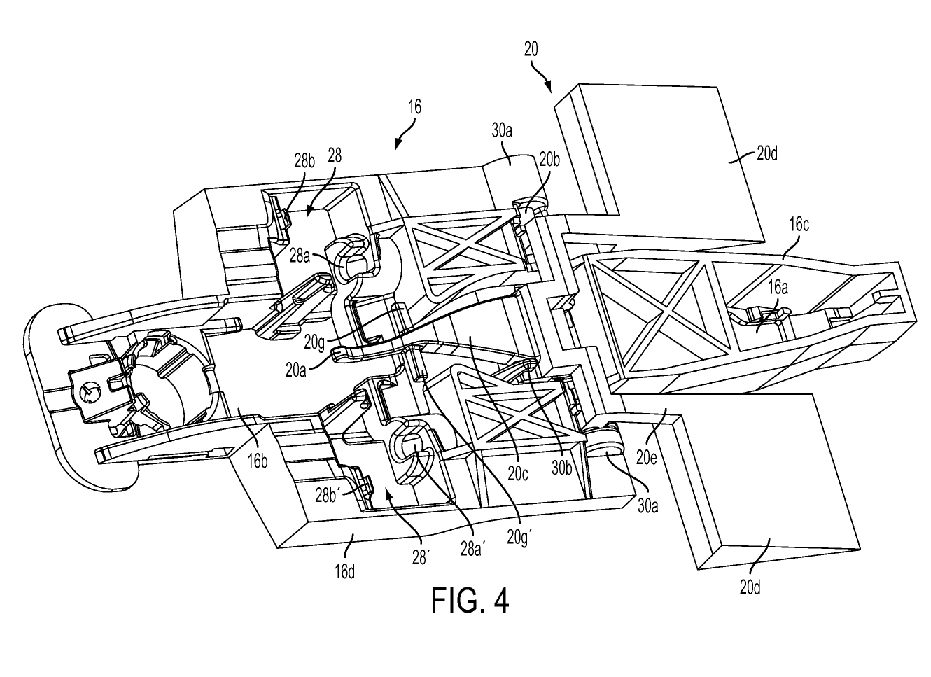

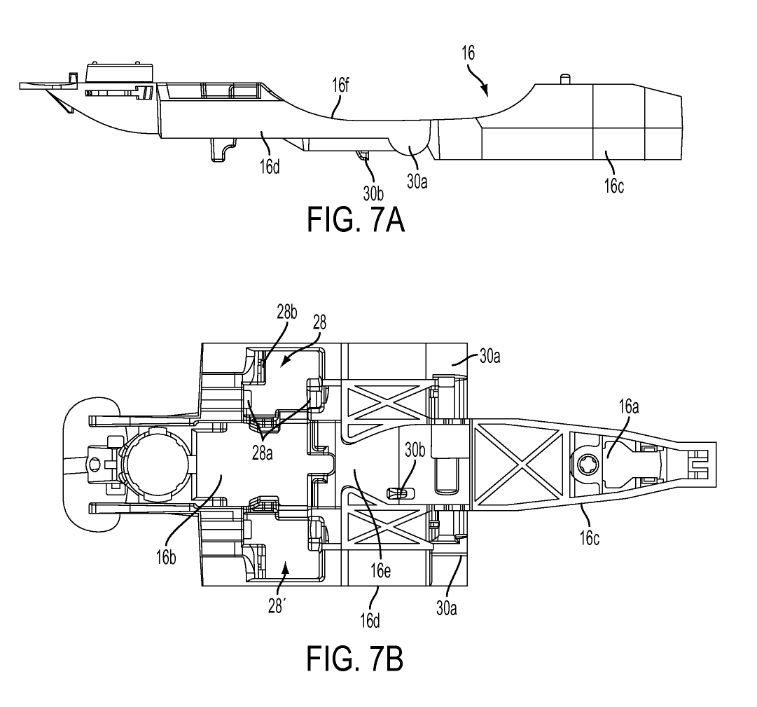

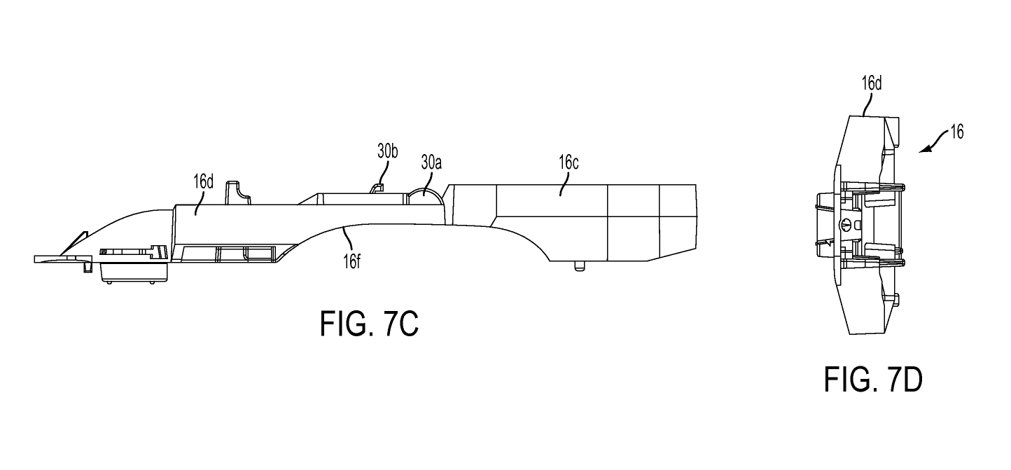

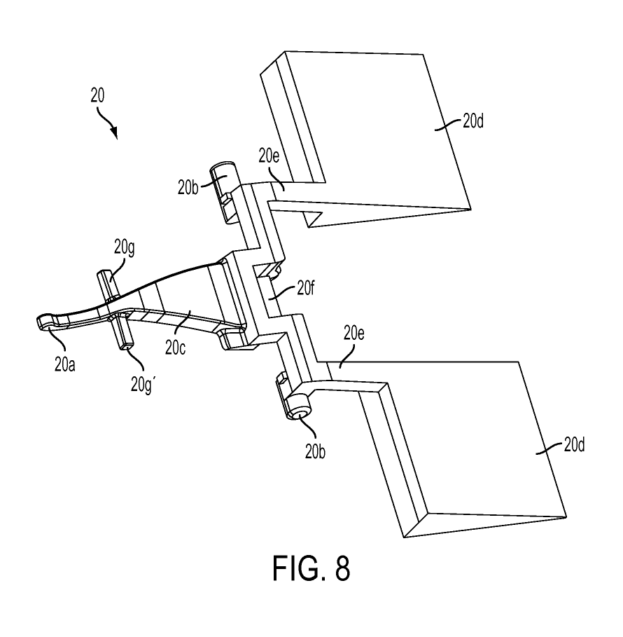

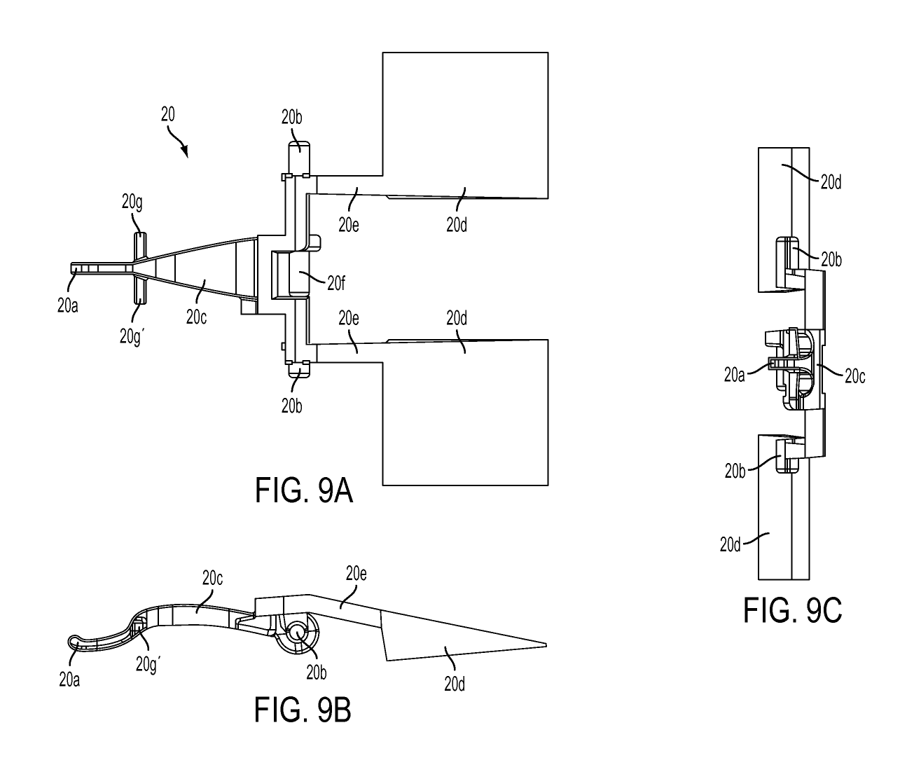

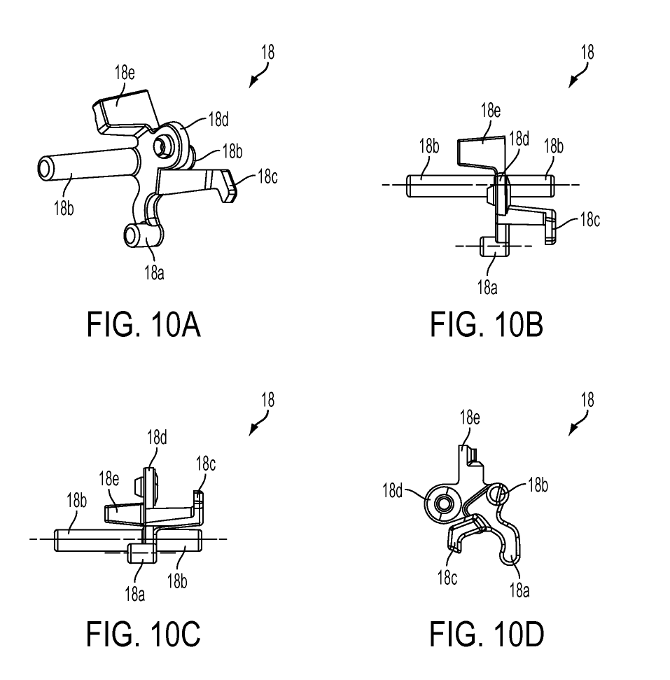

As best shown in FIGS. 4-7D, bracket 16 is mountable to the vehicle door and includes a front opening 16a for receiving front mounting element 24a of handle portion 14 and a rear opening 16b for receiving rear mounting element 26a of handle portion 14. Front mounting element 24a may be pivotally mounted to bracket 16, such as via a pivot axle or pin or the like, while rear mounting element 26a is movably received through opening 16b and is movable relative to and through bracket 16 as handle portion 14 is pulled and released by a user.

Bracket 16 includes a receiving portion or structure 28 for receiving an axle portion 18b of actuating element 18 so that actuating element 18 is pivotally mounted to bracket 16. In the illustrated embodiment, receiving portion 28 includes apertures or elements 28a for pivotally mounting axle portion 18b of actuating element 18 to bracket 16, and may include a retaining tab 28b for holding actuating element 18 at a staging position during assembly of the door handle assembly at the vehicle door, as discussed below.

Bracket 16 also includes a receiving portion or structure 30 for receiving an axle portion 20b of counterweight 20 so that counterweight 20 is pivotally mounted to bracket 16. Receiving portion 30 may include a pair of axle receiving elements 30a for pivotally receiving axle portions 20b of counterweight 20 to bracket 16, and may include a stop element or tab 30b for limiting pivotal movement of counterweight 20 when handle portion 14 is in its non-opening or released position. In the illustrated embodiment, bracket 16 is shaped to have a narrower front region or portion 16c and a wider rear region or portion 16d to accommodate the counterweight structure, as discussed below. Bracket 16 is formed to have a curved outer surface 16f that may correspond to a handle pocket or the like at the outer panel or surface of the vehicle door and at the door handle (in order to provide an indentation at the door handle for hand clearance), depending on the particular application of the door handle assembly. Bracket 16 also includes a channel 16e formed along wider portion 16d for receiving a body portion 20c of counterweight 20, as also discussed below.

Counterweight 20 is designed in a manner to package into a small packaging area along the bracket 16 and within the vehicle door, such as between a glass window and the outer panel of the vehicle'door. The counterweight may be designed utilizing a combination of engineering materials including but not limited to zinc, plastic, steel. Counterweight 20 includes a pair of weighted elements or weights or elements or slugs 20d (such as, for example, two steel and/or zinc (or other suitable material) slugs, which optionally may be over molded with plastic or the like) that are disposed at the forward end of a pair of arms 20e extending forwardly from the axle portions 20b of counterweight 20. When assembled to bracket 16, slugs 20d are positioned at opposite sides (or above and below) narrowed body portion 16c of bracket 16 so that bracket 16 and counterweight 20 provide a low profile assembly for mounting within a vehicle door. Counterweight 20 also includes the rearwardly disposed body portion 20c that extends rearward from the axle portions 20b and that includes connecting arm 20a that connects to rear connecting portion 14b of handle portion 14.

Counterweight 20 is biased toward a home position that generally corresponds with the orientation of the counterweight when the handle portion 14 is in a home or unpulled position or orientation. In the illustrated embodiment, a biasing element or spring 32 (such as a torsional spring or the like) is disposed at a spring mounting element 20f of counterweight 20 at or near axle portions 20b. Biasing element 32 biases or urges the counterweight toward its home position when the handle portion is not pulled outward to open the vehicle door and thus functions to draw the handle portion back toward its home position when released by a user. The counterweight 20 is pivotally mounted at the bracket 16 and is held in its home position by the spring 32 urging the counterbalance toward and/or against the stop element 30b of bracket 16. Counterweight 20 also includes an engaging arm or element or staging arm 20g that extends vertically from body portion 20c (when the door handle assembly is normally mounted at a vehicle door) and engages a retaining arm 18c of actuating element 18 when actuating element 18 is in its staging position during assembly of the vehicle door handle at the vehicle door, as discussed below.

Actuating element 18 includes axle portion 18b for pivotally mounting actuating element 18 to bracket 16. When actuating element 18 is pivotally mounted at bracket 16, connecting portion 18a of actuating element 18 extends so as to be disposed generally at rear aperture 16b of bracket 16 so that rear mounting element 26a of handle portion 14 connects to or engages connecting portion 18a and whereby actuating element 18 is pivoted about axle portion 18b when handle portion 14 is pulled outwardly by a user at the vehicle door. Actuating arm 18 also includes a latch connecting element or portion 18d that is connected to a latch release mechanism or cable or linkage or the like that is connected to the door latch, whereby pivotal movement of actuating element 18 about axle portion 18b pivots or moves latch connecting portion 18d to actuate or move the latch release mechanism to actuate the door latch and open the vehicle door. A biasing element 34 (such as a torsional spring or the like) may be disposed at axle portion 18b to bias or urge actuating element 18 toward a home position and thus to bias the handle portion 14 toward a home or non-use position when it is not being pulled by a user or when the handle portion is released by a user after opening the vehicle door.

Accordingly, When a user grabs at or grasps the handle portion and pulls outwardly away from the vehicle door, the handle portion pivots about the handle pivot axle and actuating end portion 26a pulls at actuating arm 18a, which in turn pivots actuating element 18 about the actuator pivot axle 18b relative to bracket 16. The pivotal movement of actuating element 18 pivots latch connecting element 18d, which pulls at the cable or linkage 19 to actuate or release the latch mechanism to open the vehicle door. When the handle portion 14 is released, biasing element 34 urges the actuating element 18 back toward its initial or home position, while biasing element 32 urges the counterweight 20 back toward its initial or home position. Likewise, the biasing elements 32 and 34 may urge the handle portion toward its initial or home position.

When the handle portion 14 is pulled or pivoted outwardly from the door, the counterweight 20 also pivots about its pivot axle 20b. However, due to the configuration of the counterweight and bracket, the counterweight does not extend substantially into the door cavity throughout its range of pivotal movement (as can be seen with reference to FIGS. 2A and 3A), such that the door handle assembly of the present invention is suitable for application to a vehicle door with a reduced width or reduced distance between the exterior panel and the window that may be positioned within the door when the window is at least partially rolled down or lowered. The low profile of the door handle assembly 10 may be accomplished by mounting the counter balance or weights or slugs forward of the door handle pocket, and with the weights or slugs of the counterweight on each side of a forward portion of the backing bracket, thereby providing a tighter or lower profile package within the vehicle door. Also, instead of a single weight or slug at or near the actuating element, the door handle assembly of the present invention provides two weights (one at each side of the bracket) that are spaced from the actuating element or bell crank. The counterweight is configured so that the range of pivotal movement of the counterweight is limited to be within a range corresponding generally to about the thickness of the bracket. The actuating element may be configured such that the amount or depth of extension of the latch connecting arm of the actuating element and the counterweight into the door cavity during the range of pivotal movement is about the same for both the initial and actuating positions.

The counterweight 20 is oriented so that the mass and momentum of the weights or slugs 20d will urge the counterweight toward its home position (and thus urge the handle portion toward its home position) during a sudden stop or collision of the vehicle, thereby limiting or substantially precluding the handle portion from moving Outward and opening the door of the vehicle during a collision or the like. In the event of a sudden stop (such as may occur in a collision or the like), the handle portion may tend to pivot outwardly (due to the weight of the handle portion that is outside of the handle pivot axle), but will be counter balanced and thus retained by the counterweight, which will tend to move outward as well and thus will pivot to pull the handle portion toward its home position and the actuating element toward its initial or non-opening or home position. Because the counterweight urges the handle portion and actuating element toward their home positions during a collision or sudden/rapid deceleration or stop, the counterweight limits or substantially precludes the actuating element from pulling at the cable or linkage, and thus limits or substantially precludes opening of the vehicle door during a collision or the like.

Also, by positioning the counterweight and its slugs within the low profile of the bracket, the door assembly of the present invention may not extend substantially into the door cavity and, thus, may be suitable for applications to doors having a reduced width. The low profile characteristic of the bracket and counterweight allows the door handle assembly to be implemented in narrower or reduced profile doors, such as a door having less than about one inch of clearance between the outer door panel and a movable glass window track. The bracket and counterweight may have a profile or lateral dimension (when mounted to a vehicle door) that is about one inch or less, depending on the particular application of the door handle assembly and vehicle door, and thus may be configured to be disposed in a narrow space between the outer door panel and the movable glass window of the door assembly when the glass window is at least partially lowered into the door cavity.

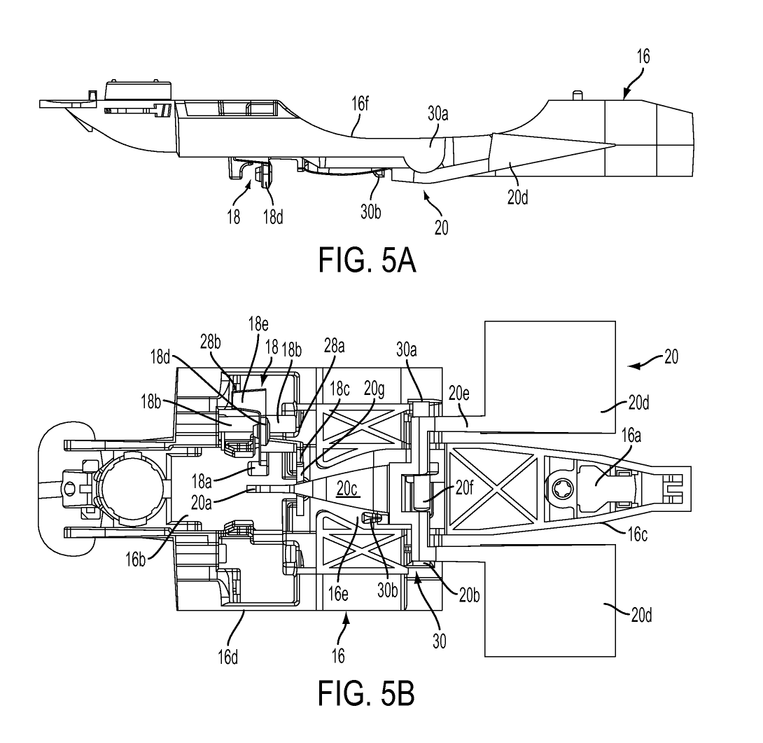

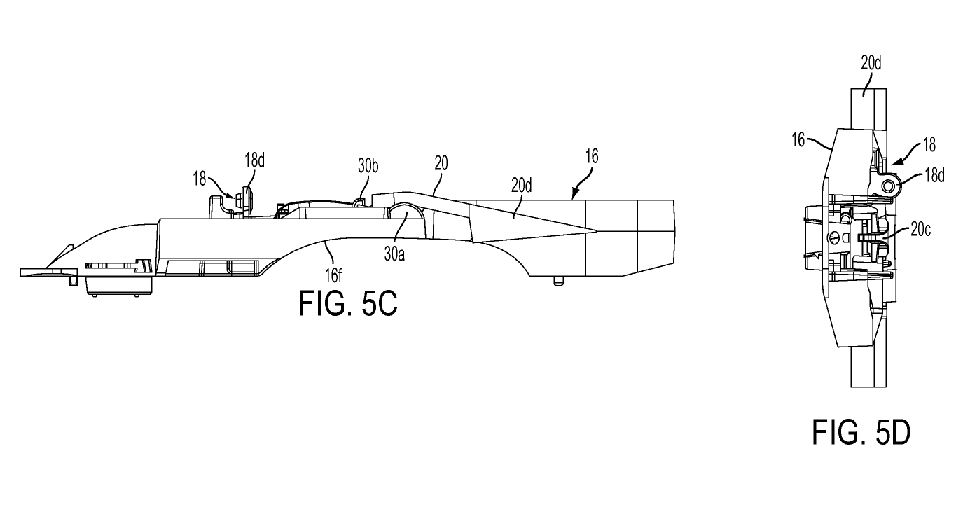

Optionally, actuating element 18 may also function to assist in the assembly of the door handle assembly at the vehicle door by providing a staging position of actuating element relative to bracket 16. When the actuating element is in the staged or staging position (such as shown in FIGS. 5B, 11, 12A-C and 13A-C, the connecting portion 18a of actuating element and the connecting arm 20a of counterweight 20 are urged outward toward the outer panel of the vehicle door so that the mounting element 26a of handle portion 14 may be readily connected to or engaged with the connecting portion 18a and connecting arm 20a during the assembly process. For example, actuating element 18 may include a retaining tab or arm 18e that is configured to engage retaining tab 28b of bracket 16 to hold the actuating element in its staging position or loading position (such as shown in FIG. 5B), and may also include counterweight engaging or retaining arm or staging arm 18c that may initially engage staging arm 20g of counterweight 20 to initially hold or urge counterweight away from its home position.

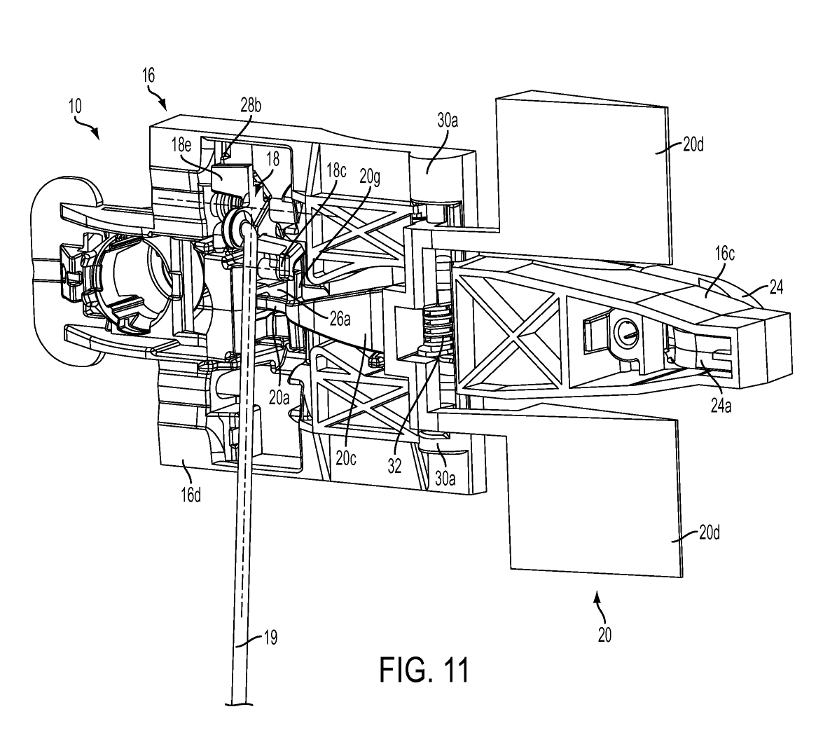

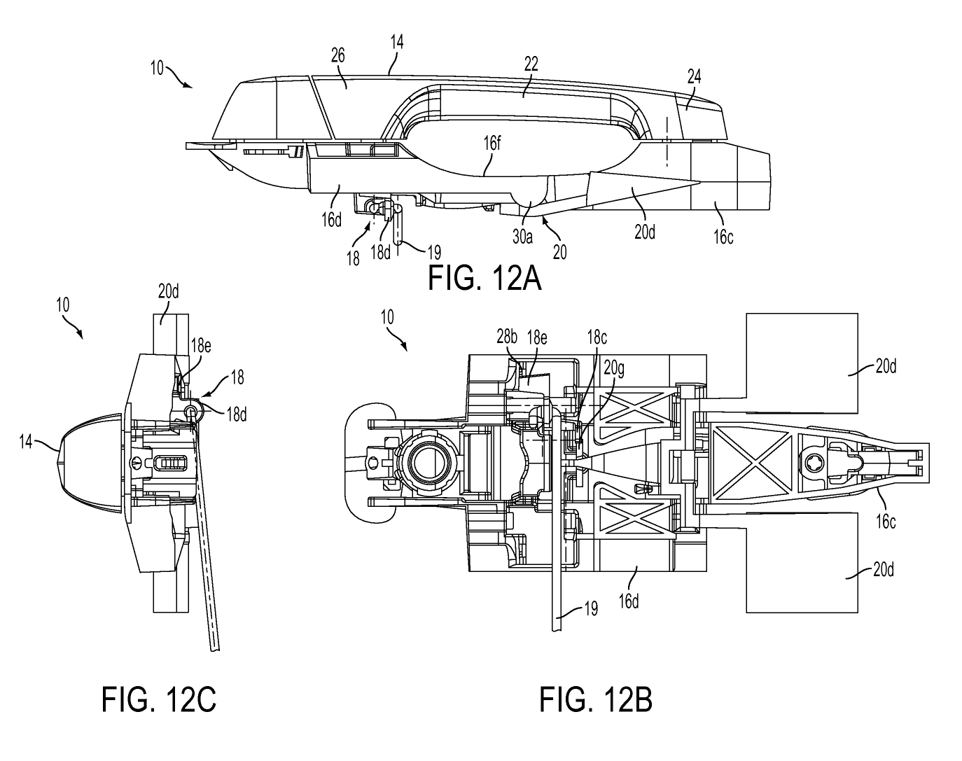

Thus, when actuating element 18 is in its staging position (such as shown in FIG. 5B) and is held there by retaining tab 18e engaging retaining tab 28b of bracket 16, the actuating element 18 and counterweight 20 are held away from their home positions to enhance the assembly process of the door handle assembly at the vehicle door, whereby handle portion 16 may be readily connected to the connecting portion 18a and connecting arm 20a (such as shown in FIGS. 11 and 12A-C). The retaining tab 18e thus limits pivotal movement of actuating element 18 and acts against the biasing forces exerted by biasing element 34 and thus retains actuating element 18 in its staging position. Preferably, biasing element 34 (or a second biasing element) may function to urge or bias actuating element 18 away from retaining tab 28b of bracket 16 (such as in a longitudinal direction along pivot axle portions 18b), so that the retaining tab 18e of actuating element 18 may be disengaged from retaining tab 28b of bracket 16 when actuating element 18 is pivoted about its axle portions 18b.

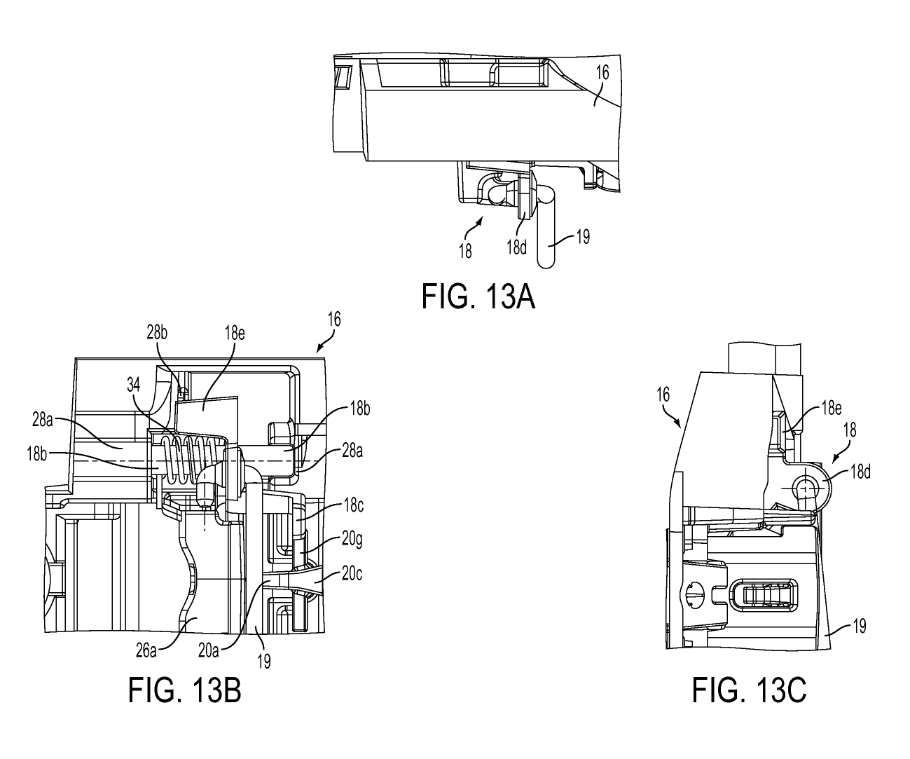

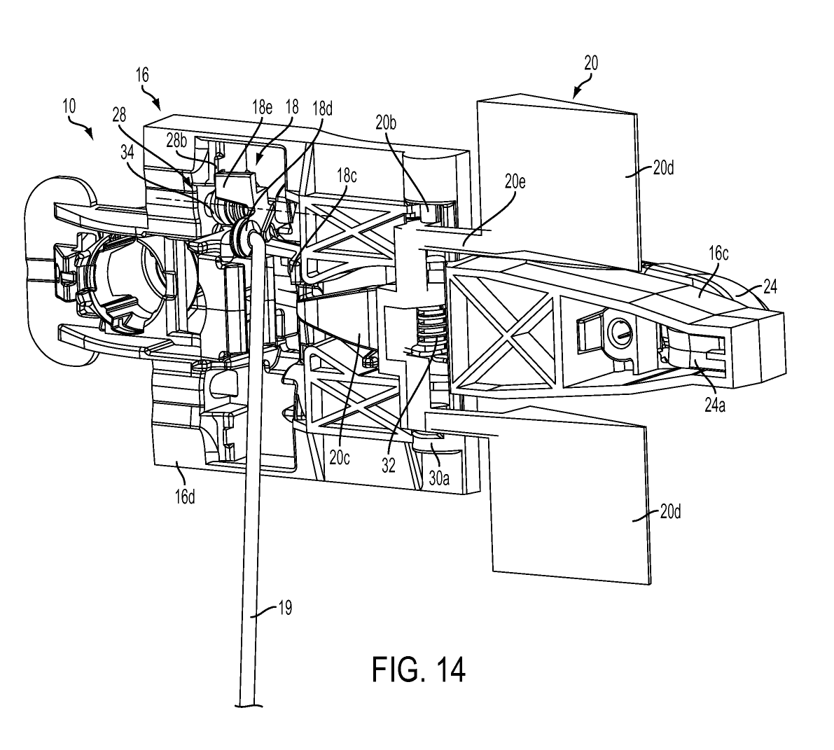

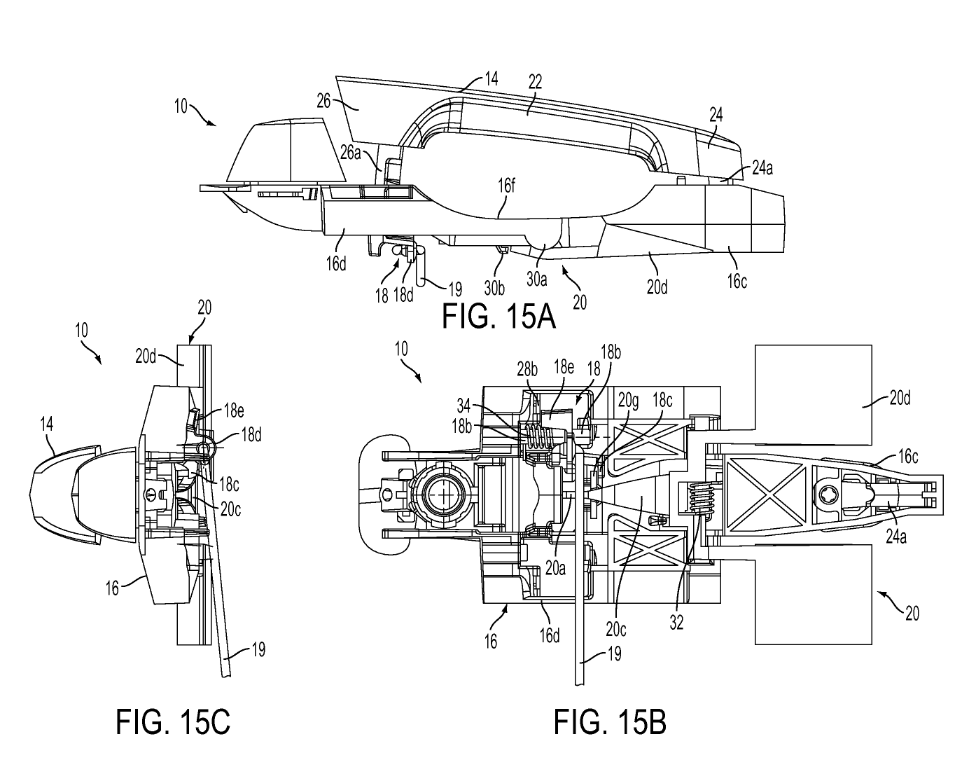

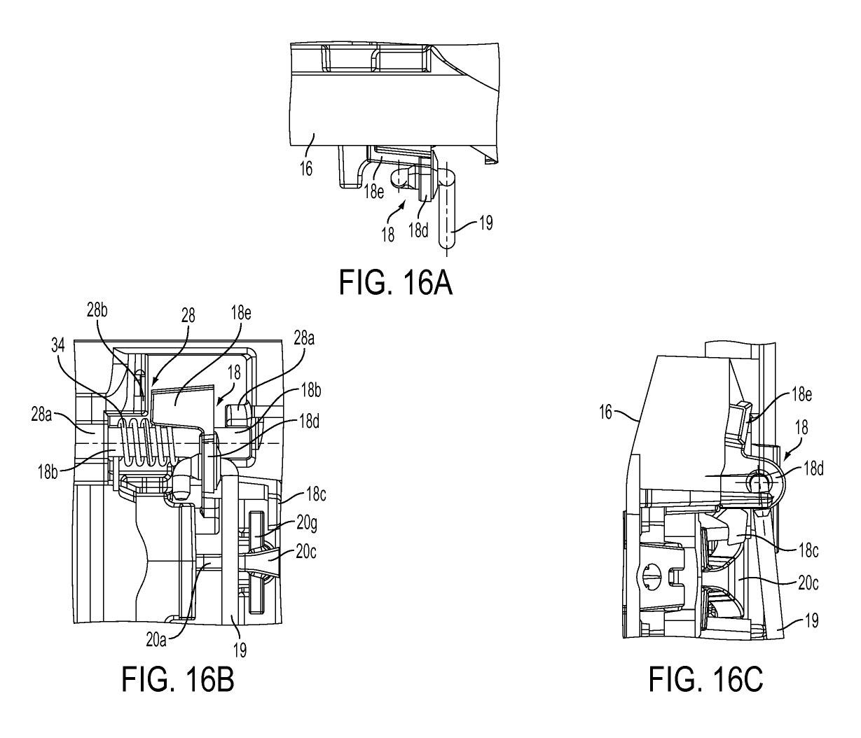

For example, and as can be seen with reference to FIGS. 14, 15A-C and 16A-C, after rear handle connecting portion 26a of handle portion 14 is connected to or engaged with the connecting portions 18a and 20a, handle portion 14 may be pulled outwardly to impart a pivotal movement of actuating element 18 about its axle portions 18b, whereby retaining tab 18e pivots away from retaining tab 28b. Upon such pivotal movement of actuating element 18, and while retaining tab 18e is disengaged from retaining tab 28b, biasing element 34 urges actuating element 18 along its pivot axis (such as to the right in FIGS. 13B and 16B) to move retaining tab 18e away from retaining tab 28b and to move retaining aim 18e away from or disengaged from staging arm 20g of counterweight 20. As can be seen in FIG. 16B, retaining tab 18e is spaced from retaining tab 28b and retaining arm 18c is spaced from staging arm 20g after actuating element 18 is moved along its pivot axis by biasing element or spring 34. Thus, upon subsequent release of handle portion 14, actuating element 18 is pivoted toward its home position (via biasing element 34) and counterweight 20 is pivoted toward its home position (via biasing element 32), with retaining tab 18e being at a location where it will not engage retaining tab 28b (and with retaining arm 18c spaced from staging arm 20g), so that actuating element 18 and counterweight 20 can pivot to their home positions and thus draw the handle portion to its home position.

Thus, the actuating element or bellcrank is staged by utilizing a rib and spring design to allow the handle portion to be loaded from the exterior of the vehicle door and to engage the bellcrank. The bellcrank includes an arm to hold the counterweight in a staging position. After engagement of the handle portion with the bellcrank and counterweight, the handle portion may be pulled outward and the bellcrank is thereby released from its staging position by the spring force and is allowed to move into a position for mechanical operation of the door handle. The pivotal movement of the bellcrank (when in its operational or non-staging position) provides for linear travel for the lock rod or cable in order to activate the latch mechanism of the vehicle door.

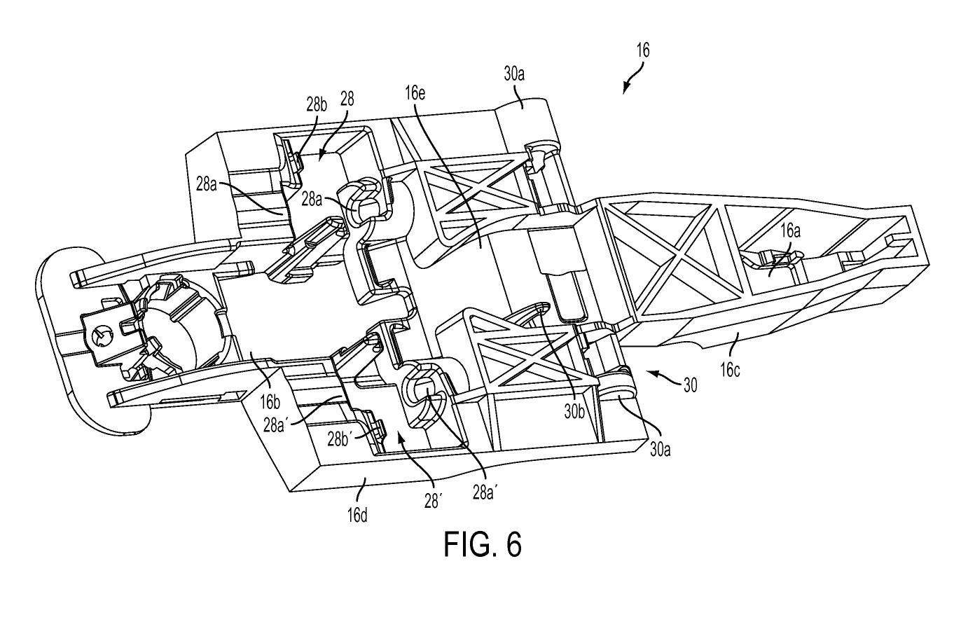

Optionally, and as shown in FIGS. 4 and 6, the bracket 16 may include an actuating element receiving portion 28, 28′ at opposite sides of rear aperture 14b (where the receiving portions 28, 28′ are above and below aperture 14b when the bracket is normally mounted in a vehicle door). Each receiving portion 28, 28′ provides an axle mounting portion 28a, 28a′ and a retaining tab 28b, 28b′, such as in a similar manner as described above. This allows a respective right or left side actuating element to be installed at the appropriate receiving portion of a common bracket to adapt the door handle assembly for the particular door or side of the vehicle (for example, driver side door or passenger side door) for which the door handle assembly is used. Likewise, the counterweight 20 includes a staging arm 20g, 20g′ at either side of body portion 20c to accommodate the actuating element at either side (above or below), depending on which side of the vehicle the door handle is installed. Thus, a common bracket and counterweight assembly may be used for either side door of a vehicle, thereby providing reduced parts and thus enhanced assembly processes for the vehicle door handle of the present invention.

Optionally, the vehicle door handle assembly of the present invention may include a soft touch handle portion, such as utilizing the principles described in U.S. Pat. Nos. 6,349,450 and 6,550,103, which are hereby incorporated herein by reference in their entireties. Optionally, the handle assembly may include an antenna or the like, such as for sensing or transmitting signals, such as described in U.S. Pat. No. 6,977,619, which is hereby incorporated herein by reference in its entirety. Optionally, the handle assembly may include an illumination source or module, such as described in PCT Application No. PCT/U.S.08/062,347, filed May 2, 2008 for ILLUMINATION MODULE FOR A VEHICLE, and/or U.S. Pat. Nos. 6,349,450 and 6,550,103, which are hereby incorporated herein by reference in their entireties, where the illumination source may illuminate the handle portion or may provide ground illumination or safety illumination, such as by utilizing aspects of the lighting systems described in U.S. Pat. Nos. 5,371,659; 5,669,699; 5,823,654; and 5,497,305, which are hereby incorporated herein by reference in their entireties. Optionally, the vehicle door handle assembly may utilize aspects of the door handle assemblies described in U.S. Pat. No. 7,407,203 and/or U.S. patent application Ser. No, 12/499,183, filed Jul. 8, 2009 (Attorney Docket DON09 P-1538), which are hereby incorporated herein by reference in their entireties.

Therefore, the present invention provides a door handle that has few components and that may be readily adapted for use at a door at either side of the vehicle. The present invention also provides a door handle that extends a reduced amount into the vehicle door, such that the vehicle door may have a reduced thickness. The door handle may position a counterweight of the door handle at least partially and preferably substantially within the base portion or bracket of the door handle assembly. The counterweight may have its pivot axis and the weights or slugs positioned forward of the actuating element and connecting portion of the door handle such that the counterweight can comprise a low profile counterweight that can provide enhanced performance of the door handle in collisions. Also, because the counterweight is pivoted each time the handle portion is actuated to open the vehicle door, the door handle assembly functions to repeatedly and periodically cycle the counterweight to limit or substantially preclude contaminants and/or corrosion from affecting the performance and movability of the counterweight over time and after the vehicle and door handle assembly have been exposed to various environmental conditions and elements, such as water, dirt, dust, salt and/or the like.

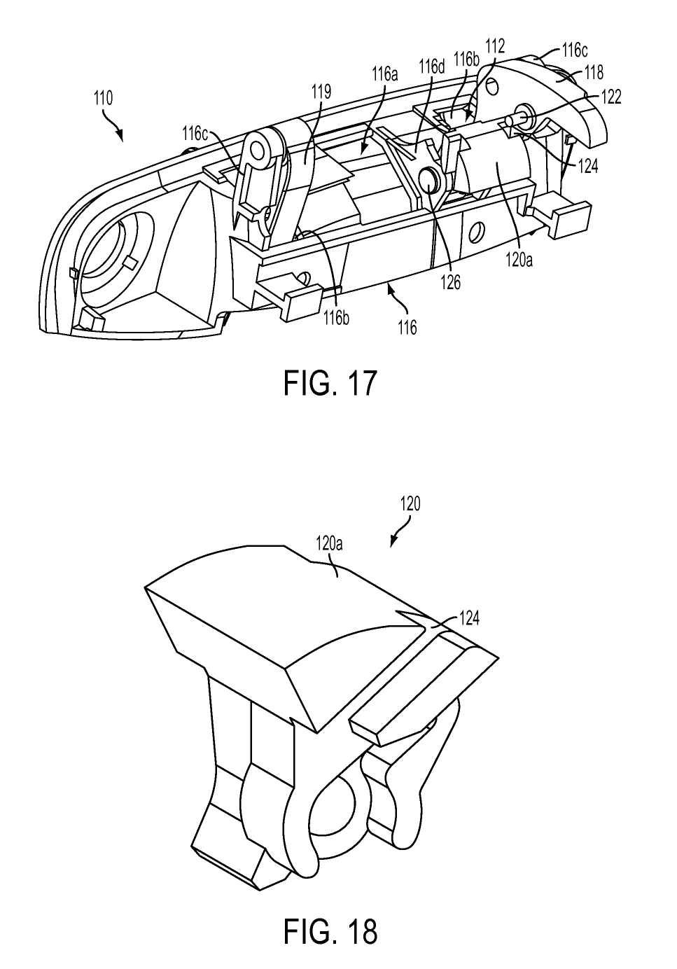

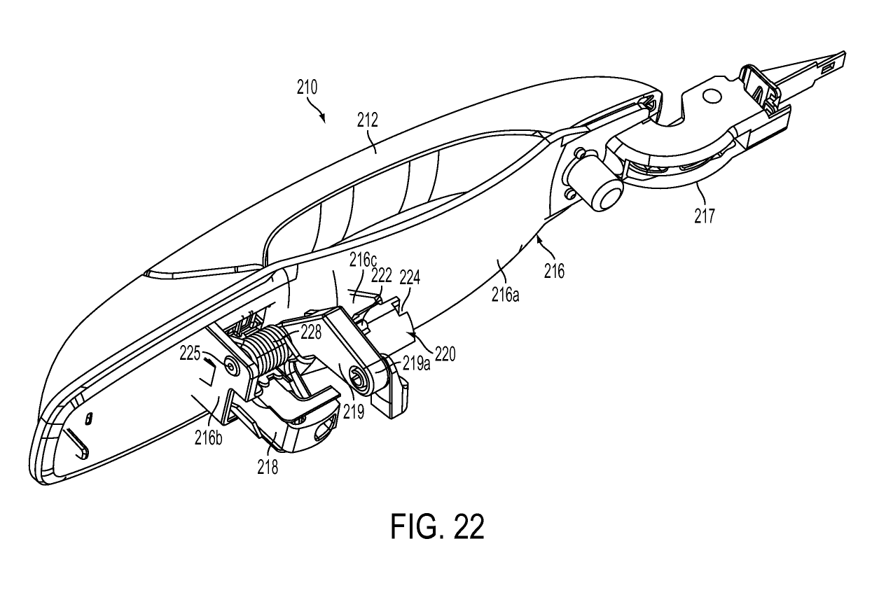

Referring now to FIGS. 17-21, a vehicle door handle assembly 110 includes a handle portion 112 (such as a paddle-type handle portion that may be pivotable about a generally horizontal pivot axis, such as shown in FIGS. 17-21, or a strap-type handle portion that may be pivotable about a generally vertical pivot axis, such as shown in FIGS. 22-26 and discussed below) that is mountable to a base portion or bracket 116, which in turn is mounted to the vehicle door and within the vehicle door. The handle portion has an actuating lever or member or element or arm 118 extending therefrom and extending through the base portion 116, whereby the actuating element engages a door latch mechanism to open the vehicle door when the handle portion is pivoted by a user. Actuating element 118 is connected to the door latch mechanism, such as via a cable or mechanical linkage or the like, such that pivotal movement by the handle portion imparts a pivotal movement of actuating element 118 to release the latch mechanism to open the vehicle door. Door handle assembly 110 includes a counterweight or counterbalance or inertia element or inertial catch mechanism 120 pivotally mounted to base portion or bracket 116. A guide pin or element 122 extends from actuating element 118 and engages a slot or channel 124 of inertial catch 120, whereby pivotal movement of the handle portion imparts a pivotal movement of actuating element 118 and moves guide pin 122 along channel 124 to impart a pivotal movement of inertia element 120, as discussed below.

Thus, the inertia element is pivoted or cycled about its pivot axis each time the handle portion is pivoted to open the vehicle door. The door handle assembly 110 thus limits or substantially precludes corrosion or contaminants from building up at the inertia element and thus limits or substantially precludes such contaminants from restricting pivotal movement of the inertia element over time. Thus, the inertia element is maintained in a functional state, with its spring, pin and die casting remaining functional by the periodic cycling or pivoting of the inertia element each time the door handle is operated to open the vehicle door.

In the illustrated embodiment, door handle assembly 110 comprises a paddle-type door handle, wherein the handle portion is pivoted about a generally horizontal pivot axis (when the door handle assembly is normally mounted to a vehicle door) to open the vehicle door. Base portion 116 may include a pocket portion or area 116a behind the handle portion to allow a user to grasp the handle portion and to pull generally outwardly and upwardly to open the vehicle door. The base portion includes a pair of apertures 116b at pocket portion 116a to allow a mounting arm 119 and actuating arm 118 (both extending from the rear or inboard side of the handle portion) to extend therethrough to pivotally mount the handle portion to base portion 116. In the illustrated embodiment, mounting arm 119 and actuating arm 118 (which may be integrally or unitarily formed or molded with the handle portion so as to be part of the handle portion) are mounted to respective ones of a pair of mounting stanchions or protrusions 116c extending from base portion 116, such as via one or more pivot pins extending through the mounting arm, actuating arm and stanchions.

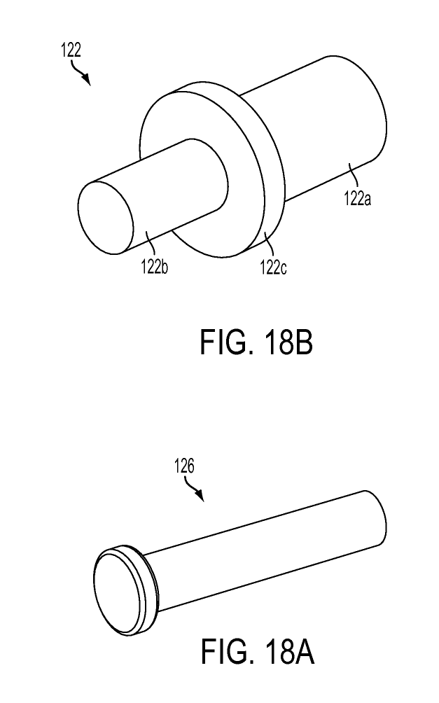

As can be seen in FIGS. 17, 19 and 20, guide pin 122 extends from an interior portion of the handle portion, such as at actuating arm 118, that is spaced from the pivot pin that mounts the handle portion to the base portion, so that pivotal movement of the handle portion and actuating arm 118 imparts an arcuate movement of guide pin 122. Guide pin 122 may comprise any suitable pin or element, and may (such as shown in FIG. 18B) have an insert portion 122a that is inserted in or received in actuating arm 118 and a guide portion 122b that extends from actuating arm 118 and is received in and moved along guide channel 124. Optionally, a larger diameter or collar portion 122c may be established to limit insertion of the guide pin 122 into an aperture in actuating arm so that the guide pin extends a desired or appropriate amount from the actuating arm. As can be seen in FIG. 17, guide pin 122 may generally align with guide channel 124 of inertia element 120, whereby arcuate movement of guide pin 122 imparts pivotal movement of inertia element 120 as guide pin 122 is moved along guide channel 124.

In the illustrated embodiment, inertia element 120 is pivotally mounted to a pair of mounting brackets or stanchions or protrusions 116d of base portion 116 via a pivot pin 126 (FIGS. 17, 18A and 19-21) that is inserted through inertia element 120 and mounting stanchions 116d. As shown in FIG. 18, guide channel 124 may comprise a generally linear channel (or may be curved or arcuate) extending in a plane that is spaced from the pivot axis or pivot pin 126 of inertia element 120. The slot is angled along the side of the inertia element at a desired or selected angle so that the guide pin 122 may readily move along the channel and pivot the inertia element during the opening of the vehicle door. Optionally, and as can be seen in FIGS. 17, 20 and 21, the inertia element may comprise a symmetrical element and may include a guide channel along each of its sides so that a common inertia element design may be used for the inertia elements of the door handle assemblies at both sides of the vehicle.

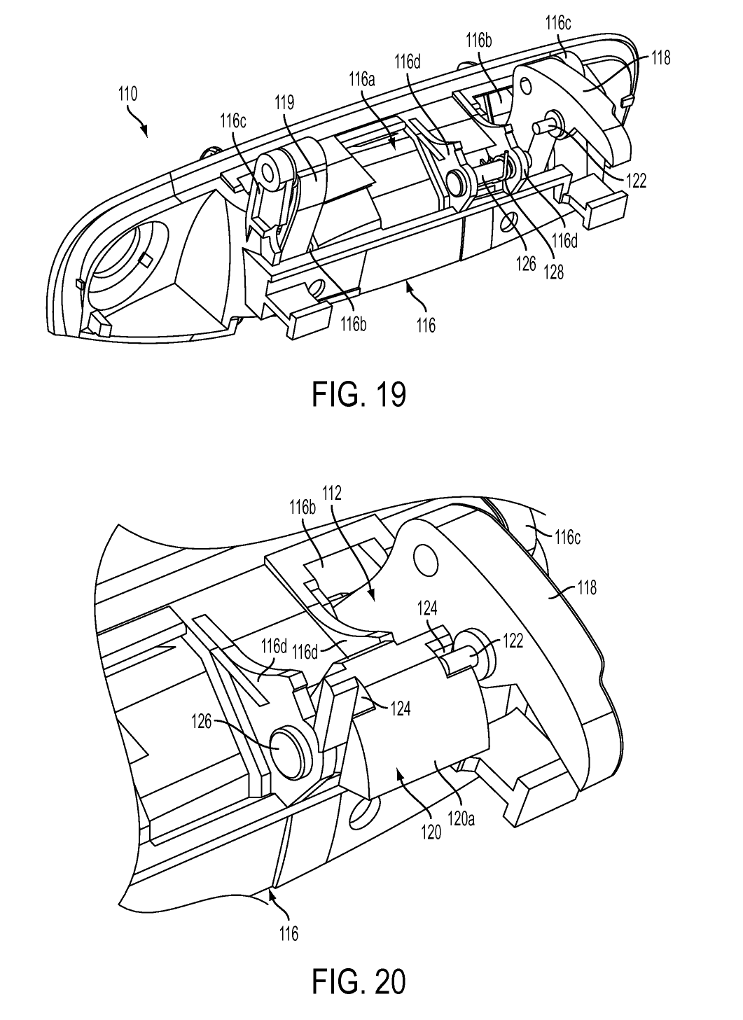

Thus, the arcuate movement of guide pin 122 along the generally linear guide channel 124 imparts a pivotal movement of inertia element 120 about its pivot axis or pivot pin 126. As can be seen in FIG. 19, handle assembly 110 may include a biasing element 128, such as a spring or torsional spring or the like, at pivot pin 126 to bias or urge inertia element 120 toward its initial or home position, which may correspond to the location of the inertia element when the door handle is in its released or not actuated state or at rest or home position (such as when the door is closed and a user is not in the act of moving the handle portion to open the vehicle door). When the inertia element is in its initial or home position, the guide pin 122 of actuating arm 118 is generally aligned with the guide channel 124 of inertia element 120.

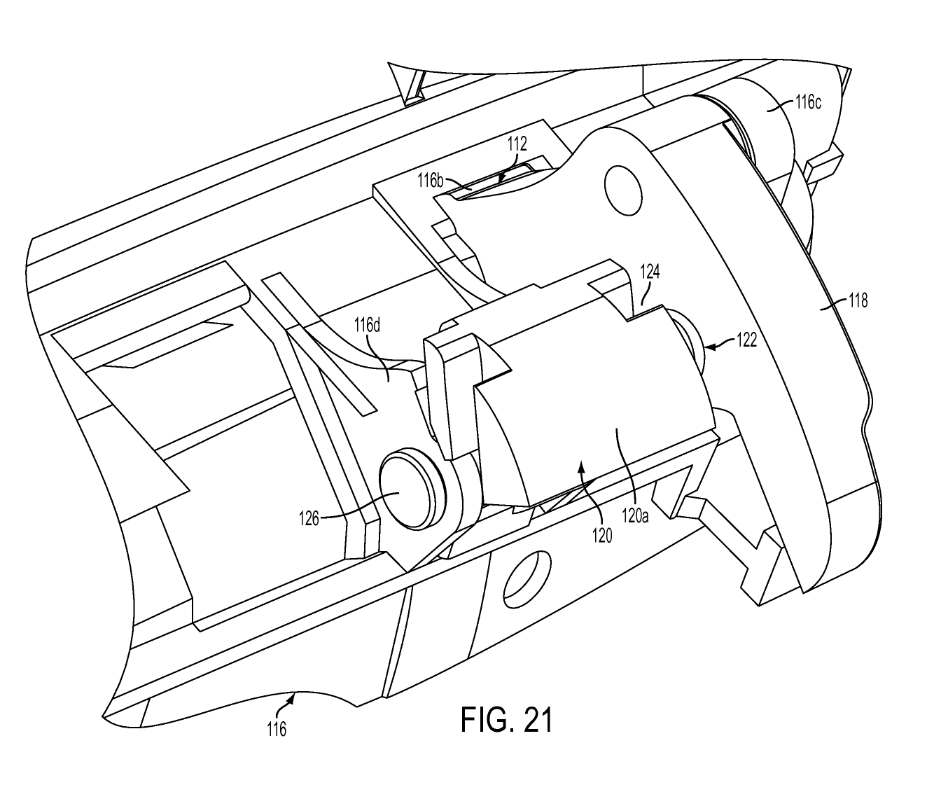

Thus, when the door handle is in its rest or non-actuated position (such as shown in FIG. 17), the inertia element 120 is positioned so as to have its guide channel 124 generally aligned with the guide pin 122 of actuating element 118. As the handle portion is moved by a user to open the vehicle door, the actuating element 118 pivots relative to the mounting stanchion 116c and guide pin 122 moves in its arcuate motion into and along guide channel 124 (such as shown in FIG. 20). When guide pin 122 is moved in this manner, the guide pin engages the walls of guide channel 124 to pivot inertia element 120 about its pivot axis (such as shown in FIG. 21), thereby cycling or pivoting the inertia element about its pivot axis during actuation of the door handle and opening of the vehicle door.

When the handle portion is released, the guide pin 122 and inertia element 120 return to their initial positions and guide pin 122 is removed from guide channel 124 (such as shown in FIG. 17). The handle assembly may include a biasing element (such as a torsional spring at a pivot pin or axle that mounts the mounting arms 118, 119 to the mounting stanchions 116c) that biases the handle portion towards its home or initial position. When in its home position and when the guide pin 122 is retracted from the guide channel 124, the inertia element 120 is then free to pivot about its pivot axis (such as in response to a sudden acceleration of the vehicle in a sideward direction, such as may typically occur during a sudden stop and/or collision of the vehicle). During a sudden stop or collision of the vehicle, the inertia element functions to pivot to a position that limits or substantially precludes the door handle from pivoting to ensure that the vehicle door will remain closed during the collision. For example, when the inertia element 120 pivots in response to a sudden stop or collision, the guide channel 124 is moved so as to not be aligned with the guide pin 122, whereby the outer surface 120a of inertia element 120 limits movement of guide pin 122 and thus limits pivotal movement of actuating arm 118 and the handle portion, thereby limiting or substantially precluding the door from opening during a sudden stop or collision.

Although shown and described as a paddle-type door handle assembly, it is envisioned that the inertia element or inertial catch of the present invention may be implemented with a strap-type door handle assembly, while remaining within the spirit and scope of the present invention. For example, and with reference to FIGS. 22-26, a vehicle door handle assembly 210 includes a strap-type handle portion 212 that is mountable to, and pivotable about a generally vertical pivot axis relative to, a base portion or bracket 216, which in turn is mounted to the vehicle door and within the vehicle door 211. The handle portion 212 has an actuating lever or member or element or arm 218 extending therefrom and extending through the base portion 216, whereby the actuating element engages a pivot arm 219 that actuates a door latch mechanism to open the vehicle door when the handle portion is pulled or pivoted by a user. Pivot arm 219 is pivotally mounted to base portion 216 and is connected at one end 219a to the door latch mechanism, such as via a cable or mechanical linkage or the like, such that pivotal movement by the handle portion imparts a pulling movement of actuating element 218 at an end portion 219b of pivot arm 219, which further imparts a pivotal movement of pivot arm 219 to release the latch mechanism to open the vehicle door. Door handle assembly 210 includes a counterweight or counterbalance or inertia element or inertial catch mechanism or inertia lock 220 pivotally mounted to base portion or bracket 216. A guide pin or element 222 extends from pivot arm 219 and engages a slot or channel 224 of inertia element 220, whereby pivotal or outward movement of the handle portion 212 imparts a pivotal movement of pivot arm 219 and moves guide pin 222 along channel 224 to impart a pivotal movement of inertia element 220, such as in a similar manner as discussed above.

In the illustrated embodiment, door handle assembly 210 comprises a strap-type door handle, wherein the handle portion is pivoted about a generally vertical pivot axis (when the door handle assembly is normally mounted to a vehicle door) to open the vehicle door. Base portion 216 may include a recessed or curved portion or area 216a behind the handle portion to allow a user to grasp the handle portion and to pull generally outwardly and upwardly to open the vehicle door. The base portion 216 is formed to allow a mounting arm 217 and actuating arm 218 (both extending from the rear or inboard side of the handle portion) to extend into the door cavity (such as through apertures or slots or openings formed at or through the base portion) to pivotally mount the handle portion to base portion 216 and vehicle door. Door handle assembly 210 may utilize aspects of the door handle assemblies described in U.S. Pat. Nos. 6,977,619 and/or 6,854,870, which are hereby incorporated herein by reference in their entireties.

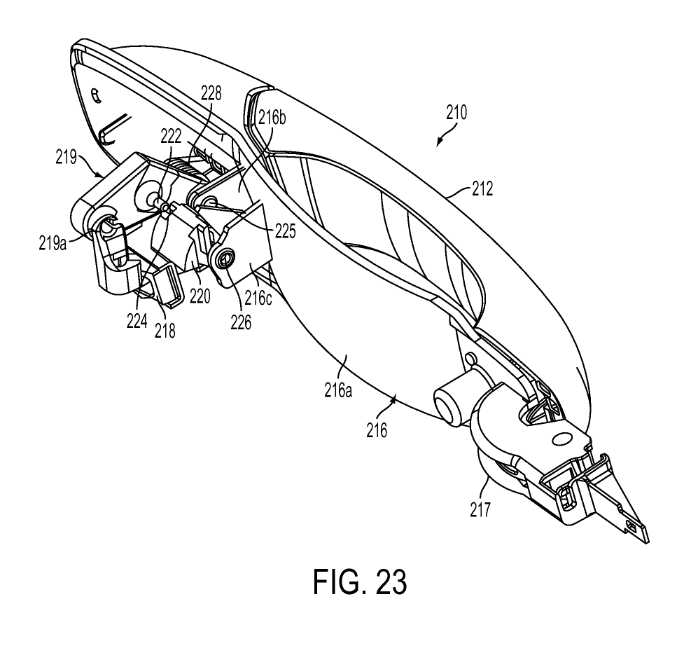

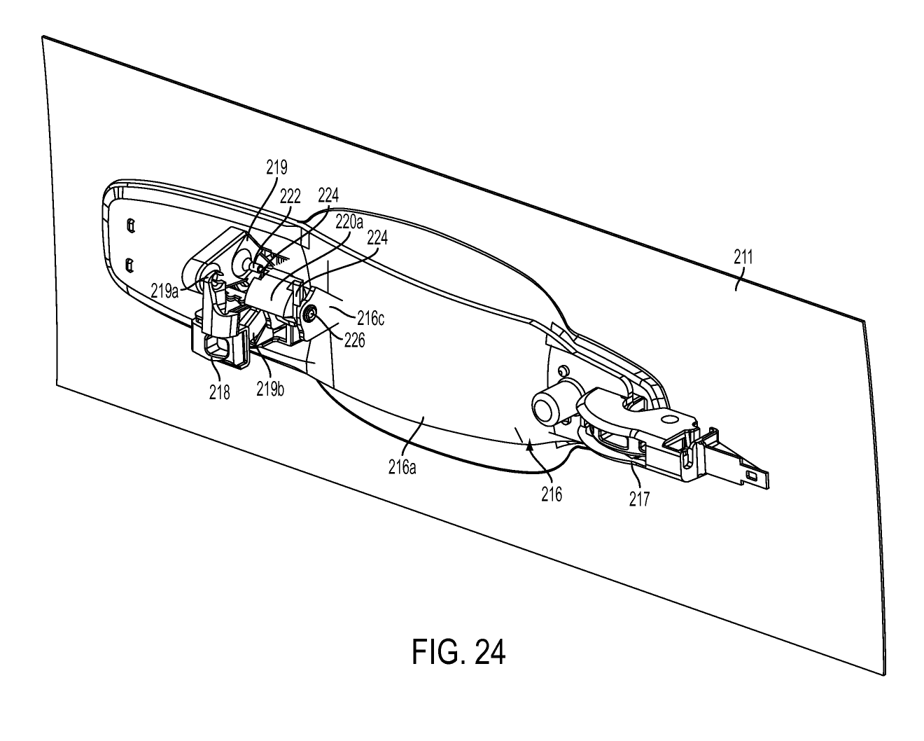

As can be seen in FIGS. 23 and 24, guide pin 222 extends from pivot arm 219 at a location that is spaced from a pivot axis of pivot arm 219 and a pivot pin 225 that mounts the pivot arm to the base portion (such as at a pair of stanchions 216b of base portion), so that pivotal movement of the pivot arm 219 imparts an arcuate movement of guide pin 222 relative to the base portion. Guide pin 222 may comprise any suitable pin or element, and extends from pivot arm 219 and is received in and moved along guide channel 224 of inertia element 220. As can be seen in FIGS. 23 and 24, guide pin 222 may generally align with guide channel 224 of inertia element 220, whereby arcuate movement of guide pin 222 imparts pivotal movement of inertia element 220 as guide pin 222 is moved along guide channel 224 of inertia element 220.

In the illustrated embodiment, inertia element 220 is pivotally mounted to a pair of mounting brackets or stanchions or protrusions 216c of base portion 216 via a pivot pin 226 (FIGS. 23 and 24) that is inserted through inertia element 220 and mounting stanchions 216c. As shown in FIGS. 23 and 24, guide channel 224 may comprise a generally linear channel (or may be curved or arcuate) extending in a plane that is spaced from the pivot axis or pivot pin 226 of inertia element 220. The slot is angled along the side of the inertia element at a desired or selected angle so that the guide pin 222 may readily move along the channel and pivot the inertia element during the opening of the vehicle door. Optionally, the inertia element may comprise a symmetrical element and may include a guide channel along each of its sides so that a common inertia element design may be used for the inertia elements of the door handle assemblies at both sides of the vehicle.

Thus, the arcuate movement of guide pin 222 along the generally linear guide channel 224 imparts a pivotal movement of inertia element 220 about its pivot axis or pivot pin 226. As can be seen in FIGS. 22, 23 and 25, handle assembly 210 may include a biasing element 228, such as a spring or torsional spring or the like, at pivot pin 225 to bias or urge pivot arm 219 and inertia element 220 toward their initial or home positions, which may correspond to the location of the inertia element when the door handle is in its released or not actuated state or at rest or home position (such as when the door is closed and a user is not in the act of moving the handle portion to open the vehicle door). When the inertia element is in its initial or home position, the guide pin 222 of actuating arm 218 is generally removed from and generally aligned with the guide channel 224 of inertia element 220 (such as shown in FIGS. 23 and 24).

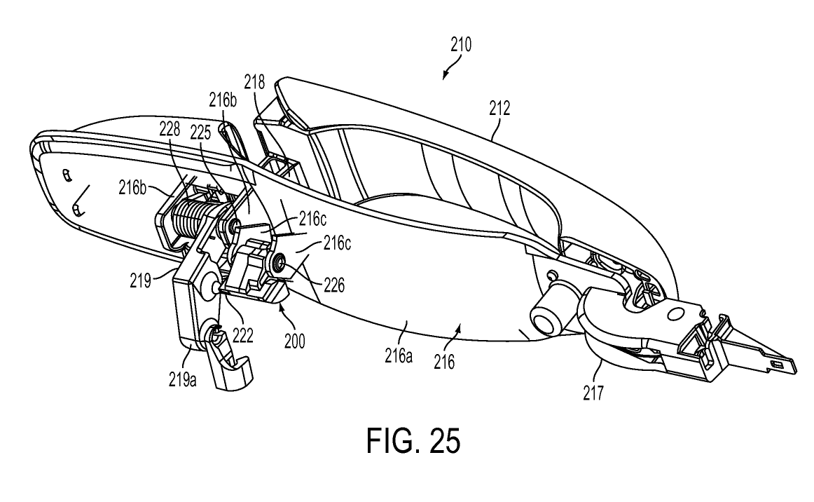

Thus, when the door handle is in its rest or non-actuated position (such as shown in FIGS. 22-24), the inertia element 220 is positioned so as to have its guide channel 224 generally aligned with the guide pin 222 of pivot arm 219. As the handle portion is moved by a user to open the vehicle door, the actuating element 218 pivots pivot arm 219 relative to the mounting stanchions 216b and guide pin 222 moves in its arcuate motion into and along guide channel 224 of inertia element 220. When guide pin 222 is moved in this manner, the guide pin engages the walls of guide channel 224 to pivot inertia element 220 about its pivot axis (such as shown in FIG. 25), thereby cycling or pivoting the inertia element about its pivot axis during actuation of the door handle and opening of the vehicle door.

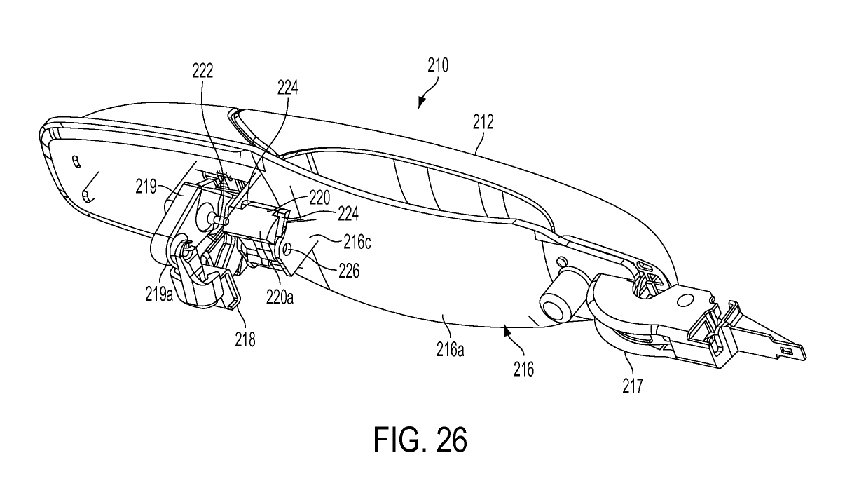

When the handle portion is released, the guide pin 222 and inertia element 220 return to their initial positions and guide pin 222 is removed from guide channel 224 (such as shown in FIGS. 23 and 24). When in its home position and when the guide pin 222 is retracted from the guide channel 224, the inertia element 220 is then free to pivot about its pivot axis (such as in response to a sudden acceleration of the vehicle in a sideward direction, such as may typically occur during a sudden stop and/or collision of the vehicle). During a sudden stop or collision of the vehicle, the inertia element functions to pivot to a position that limits or substantially precludes the door handle from pivoting to ensure that the vehicle door will remain closed during the collision. For example, and as can be seen in FIG. 26, when the inertia element 220 pivots in response to a sudden stop or collision, the guide channel 224 is moved so as to not be aligned with the guide pin 222, whereby the outer surface 220a of inertia element 220 limits movement of guide pin 222 and thus limits pivotal movement of pivot arm 219 and movement of actuating arm 218 and the handle portion 212, thereby limiting or substantially precluding the door from opening during a sudden stop or collision.

Thus, the inertia element is pivoted or cycled about its pivot axis each time the handle portion is pivoted to open the vehicle door. The door handle assembly thus limits or substantially precludes corrosion or contaminants from building up at the inertia element and thus limits or substantially precludes such contaminants from restricting pivotal movement of the inertia element over time. Thus, the inertia element is maintained in a functional state, with its spring, pin and die casting remaining functional by the periodic cycling or pivoting of the inertia element each time the door handle is operated to open the vehicle door.

The inertia element or counterweight or inertial catch thus provides a safety feature for the vehicle during a vehicle collision, and thus it is desirable to have the inertia element perform as it is designed and intended throughout the lifetime of the vehicle during use of the vehicle in a variety of driving conditions and with exposure to a variety of environments. With conventional counterweights or inertia elements, corrosion of components may occur or contaminants may foul the components, whereby the frictional resistance to movement of the counterweight may increase substantially. Over time, the resistance to movement of the inertial catch or counterweight may increase to a level that does not allow the inertial catch or counterweight to quickly move to its appropriate position to limit opening of the door and the inertial catch or counterweight may eventually lock up or freeze and may not function during a sudden stop or collision of the vehicle.

The present invention reduces or overcomes such concerns by periodically and repeatedly cycling the inertial catch or inertia element about its pivot pin (such as each time the handle portion is moved by a user to open the vehicle door) to limit or substantially preclude build up of contaminants and/or corrosion at the inertia element (such as at the pivot pin and/or spring at the inertia element) and to maintain the frictional resistance to movement of the inertia element at a reduced or consistent level. Thus, if the vehicle suddenly stops and/or is in a collision, the inertia element will be free or substantially free to move or pivot and thus to function in its intended manner, even if such a sudden stop or collision occurs after the vehicle has been driven for several years. The handle assembly of the present invention keeps the inertia element or inertial catch or counterweight free by the engagement and motion of the inertia element during the normal cycling of the handle, and thus limits or substantially precludes lockup of the inertia element. The slot or channel of the inertia element allows for relatively free movement of the handle during a normal door opening operation, but is angled to impart a motion to the inertia element when the handle is actuated or moved to open the vehicle door. When the inertia element is pivoted due to a sudden acceleration or sudden stop or collision, the inertia element limits or substantially precludes pivotal movement of the handle to limit or substantially preclude opening of the vehicle door.

Changes and modifications to the specifically described embodiments may be carried out without departing from the principles of the present invention, which is intended to be limited only by the scope of the appended claims as interpreted according to the principles of patent law.

The embodiments of the invention in which an exclusive property or privilege is claimed are defined as follows:

1. A door handle assembly for a door of a vehicle, said door handle assembly comprising:
a bracket mountable to the vehicle door;
a handle portion configured to pivotally attach to said bracket and pivotable between an initial position, where said handle portion is positioned generally along the vehicle door, and an actuating position, where said handle portion is pivoted away from the vehicle door;
an actuating element pivotally mounted to said bracket, said actuating element connecting to a release mechanism of the vehicle door so as to actuate the release mechanism when said actuating element is pivoted relative to said bracket; and
a counterweight pivotally mounted to said bracket, said counterweight extending along said bracket, said counterweight and said bracket comprising a low profile assembly.

2. The door handle assembly of claim 1, wherein said bracket is mountable to an outer door sheet metal component of the vehicle door that is configured with an indentation for hand clearance, and wherein said counterweight extends along said bracket above and below said hand clearance.

3. The door handle assembly of claim 1, wherein said actuating element includes an arm with a cylindrical protrusion, said cylindrical protrusion engaging said handle portion.

4. The door handle assembly of claim 1, wherein said counterweight extends forwardly along said bracket when said door handle assembly is normally mounted at a vehicle door.

5. The door handle assembly of claim 4, wherein said counterweight includes a pivot axle that is pivotally mounted to said bracket, a connecting arm that is disposed rearwardly of said pivot axle when said door handle assembly is normally mounted at a vehicle door, and at least one weighted element disposed forwardly of said pivot axle when said door handle assembly is normally mounted at a vehicle door.

6. The door handle assembly of claim 5, wherein said at least one weighted element comprises a pair of weighted elements disposed at either side of said bracket.

7. The door handle assembly of claim 1, wherein said actuating element includes a retaining arm for engaging a retaining tab at said bracket to at least initially retain said actuating element in a staging orientation relative to said bracket during assembly of said door handle assembly at the vehicle door.

8. The door handle assembly of claim 7, wherein said counterweight includes a staging arm that is engagable with a staging arm of said actuating element when said actuating element is in said staging orientation so that said counterweight is at least initially retained in a counterweight staging orientation relative to said bracket during assembly of said door handle assembly at the vehicle door.

9. The door handle assembly of claim 8, wherein, when said handle portion is pivoted relative to said bracket, said actuating element is pivoted to disengage said retaining arm from said retaining tab of said bracket, and wherein, when said retaining arm is disengaged from said retaining tab of said bracket, said actuating element is moved along its pivot axis relative to said bracket to an operable position with said retaining arm spaced from said retaining tab and with said staging arm of said actuating element spaced from said staging arm of said counterweight.

10. The door handle assembly of claim 9, wherein, when said actuating element is in said operable position, said actuating element is pivotable about its pivot axis via movement of said handle portion and without engagement of said retaining arm with said retaining tab and without engagement of said staging arm of said actuating element with said staging arm of said counterweight.

11. The door handle assembly of claim 1, wherein said bracket and said counterweight are configured for mounting to a door at either side of a vehicle.

12. The door handle assembly of claim 1, wherein pivotal movement of said handle portion imparts a pivotal movement of said counterweight during normal operation of said door handle assembly to open the vehicle door.

13. A door handle assembly for a door of a vehicle, said door handle assembly comprising:
a bracket mountable to the vehicle door;
a handle portion configured to pivotally attach to said bracket and pivotable between an initial position, where said handle portion is positioned generally along the vehicle door, and an actuating position, where said handle portion is pivoted away from the vehicle door, and wherein pivotal movement of said handle portion actuates a release mechanism of the vehicle door to open the vehicle door; and
an inertial catch pivotally mounted to said bracket, wherein pivotal movement of said handle portion imparts a pivotal movement of said inertial catch during normal operation of said door handle assembly to open the vehicle door.

14. The door handle assembly of claim 13, wherein said inertial catch comprises a first engaging surface and a second engaging surface, wherein acceleration of said vehicle due to a collision or sudden stop, causes said handle portion to engage said first engaging surface to limit opening of the vehicle door, and wherein normal operation of said door handle assembly to open the vehicle door causes said handle portion to engage said second engaging surface and pivotally move said inertial catch.

15. The door handle assembly of claim 14, wherein said handle portion includes a guide pin extending therefrom, and wherein said second engaging surface of the inertial catch comprises a guide channel, wherein said guide pin engages said guide channel and wherein pivotal movement of said handle portion imparts movement of said guide pin along said guide channel to impart pivotal movement of said inertial catch during normal operation of said door handle assembly.

16. The door handle assembly of claim 15, wherein said first engaging surface comprises an outer surface of said inertial catch, and wherein acceleration of said vehicle due to a collision or sudden stop causes said guide pin to not engage said guide channel and to engage said first engaging surface to limit opening of the vehicle door.

17. The door handle assembly of claim 13, wherein said handle portion is pivotable about a generally horizontal pivot axis when said door handle assembly is normally mounted at a door of a vehicle.

18. The door handle assembly of claim 13, wherein said handle portion is pivotable about a generally vertical pivot axis when said door handle assembly is normally mounted at a door of a vehicle.

19. The door handle assembly of claim 13, wherein an actuating element of said door handle assembly is pivotable with said handle portion, said actuating element connecting to the release mechanism of the vehicle door so as to actuate the release mechanism when said actuating element is pivoted relative to said bracket.

20. The door handle assembly of claim 19, wherein one of said handle portion and said actuating element includes a guide pin extending therefrom, and wherein said guide pin engages a guide channel of said inertial catch, and wherein pivotal movement of said handle portion imparts movement of said guide pin which moves along said guide channel to impart pivotal movement of said inertial catch.

21. The door handle assembly of claim 20, wherein said inertial catch includes a guide channel along opposite sides of said inertial catch so that said inertial catch can be used in a door handle assembly of a vehicle door at either side of the vehicle.

22. The door handle assembly of claim 19, wherein said handle portion is unitarily formed with said actuating element.
